(19) United States
(12) Patent Application Publication
(10) Pub. No.: US 2002/0046262 A1
(43) Pub. Date: Apr. 18, 2002

(54) Data access system and method with proxy and remote processing

(76) Inventors: Joerg Heilig, Hamburg (DE); Thorsten Laux, Hamburg (DE)

Correspondence Address: SUN MICROSYSTEMS INC, 901 SAN ANTONIO RD, MS PALO1-521, PALO ALTO, CA, 94303, US

(21) Appl. No.: 09/931,844

(22) Filed: Aug. 16, 2001

Related U.S. Application Data
(60) Provisional application No. 60/279,564, filed on Mar. 28, 2001.

(30) Foreign Application Priority Data
Aug. 18, 2000 (EP) 00 117 311.1

(51) Int. Cl. G06F 15/16

(52) U.S. Cl. 709/219

(57) ABSTRACT

Apparatus and methods of accessing and visualizing data stored at a remote host on a computer network are disclosed. A proxy server receives a request for data from a client, and, in response, makes a determination whether the data specified in the request should be rendered. If the proxy server determines that the requested data should be rendered, the proxy server then transmits a rendering determination to a processing server coupled to the proxy server. The proxy server then renders the requested data and transmits the rendered data to the client.

### CROSS-REFERENCE TO RELATED APPLICATIONS

The following-identified U.S. and foreign patent applications are relied upon and are incorporated by reference in this application.

European Application No. 00 117 311.1 entitled DATA ACCESS SYSTEM AND METHOD WITH PROXY AND REMOTE PROCESSING, filed on Aug. 18, 2000; and U.S. Provisional Patent Application No. 60/279,564, entitled DATA ACCESS SYSTEM AND METHOD WITH PROXY AND REMOTE PROCESSING, filed on Mar. 28, 2001.

### BACKGROUND OF THE INVENTION

1. Field of the Invention

The present invention relates to a data access system and method for accessing data in a network.

2. Description of Related Art

In today's data communication networks a user may access information at virtually any arbitrary location. Various types of computer networks with data servers, and combinations thereof are available, e.g. public packet switched networks such as the Internet or local area networks such as a company wide intranet.

If for example a user operating a user data processing device is connected to a network of data processing devices such as the Internet and uses, e.g., a standard “browser” application (in the following referred to as a browser) to access information, for example a HTML (hyper text markup language) document, available at a data server located somewhere in the network, the browser will generate and send a corresponding request via the network to the appropriate server storing the requested document.

A request generally includes information identifying the desired document and necessary routing information like address information of the target data server and the client computer, i.e., the user data processing device and running the browser. In response to receiving the request from the client, the data server will retrieve and transmit the requested document to the client for further processing or rendering.

This process, however, requires the browser to have the capability of handling the received data and performing the necessary processing operations for actually displaying the information. In case of an HTML-language document, nowadays virtually any available browser has the tools necessary for document interpretation and display. In this case, upon receiving the associated data, the browser may directly interpret and render the data for display or launch the required processing software needed for displaying the information. The same applies to, e.g. image data in one of the standard formats, such as JPEG, GIF, BMP and any other document in a standard format.

However, a browser run at the user data processing device obviously does not necessarily have the capability to handle certain types of information. Such a browser may, upon receiving information that can not be interpreted, for example prompt the user that no suitable application processing program or data handler for visualizing or handling the received information is available.

Transcoding techniques are known which permit the conversion of data between different representations at an intermediate proxy server when data stored at a data server is requested at a client, e.g. a Web client connected to the Internet. See, for example, Jeffrey C. Mogul, “Server-directed Transcoding”, 5^{th} INTERNATIONAL WEB CACHING AND CONTENT DELIVERY WORKSHOP: PROCEEDINGS ONLINE (Lisbon, Portugal, May 22, 2000) (XP002162540), retrieved from the Internet on Mar. 9, 2001 at URL http://www.iwcw.org/2000/Proceedings/S1/S1-4.ps. However, such techniques may use implicit information included in the data requested, such as an HTTP content-type header in an HTML document, to decide whether and how to convert. However, such implicit information can be ambiguous, and may thus lead to incorrect conversion decisions. Other techniques include server-directed transcoding, as described in the cited publication, which uses explicit guidance from the origin data server to allow an intermediate transcoding proxy server to make the best possible data conversion choice prior to displaying data at the client.

An alternate approach, discussed by C. Freytag et al. in “Resource adaptive WWW access for mobile applications”, Computers & Graphics, vol. 23 (1999), pages 841-848. This approach allows integration of mobile computing devices within the World Wide Web infrastructure, utilizing a rules-based approach, including user preferences and device properties, to evaluate dynamically the most appropriate adaptation strategy for displaying Web content on mobile devices.

However, such techniques deal only with converting existing data from one known format to another known format for display on a client device. Thus, such techniques known in the prior art are not capable of performing additional processing or rendering operations, such as rearranging data, or extracting and providing specific parts of a data file for visualization and/or editing.

One solution to this problem is to provide a “smart” proxy capable of examining the data passing through it and dynamically acting upon that data based upon predetermined selection criterion. An example of this approach includes International Publication Number WO 98/43177, entitled “System for Dynamically Transcoding Data Transmitted Between Computers”, of Michael M. Tso et al., published on Oct. 1, 1998. However, this system relies on a proxy server to examine all data passing through it in all directions, and to perform additional processing of that data dynamically based on criterion or conditions known by the proxy server.

Thus, these known proxy servers described in the above examples may perform data conversions based on information known by the proxy server, information implicit within the data, or based on information received from the origin data server, about what data is essential and what is not. Such proxy servers cannot receive specific processing or rendering instructions from a client, and are thus unable to provide data in particular configurations or formats in accordance with a specific client request. Furthermore, such proxy servers process all data transmitted between the client and the data server. Thus such systems are not capable of designating more efficient pathways for transmitting data, such as transmitting data directly to a client device from a data server or a processing server, without having to go through an intermediate proxy device.

As a solution of this problem it is conceivable to retrieve the required tools or programs from somewhere on the network. However, although such programs may be available on the Internet at low cost or no cost, it nevertheless may be difficult to retrieve these tools when needed.

Alternatively, it may be possible to transmit the received data, which may not be handled at the client browser, to a dedicated site somewhere else in the network having the capabilities to perform the required processing operations on behalf of the client. Such a dedicated site may be able to convert the received data into a data format that may be handled at the client browser.

Further, it is conceivable that a browser, even though being capable to handle the requested data, should not handle the data itself but instead the data should be handled at a dedicated site, for example in order to reduce a processing load at the user data processing device.

However, in case documents containing large amounts of data are requested by a client, for example in the megabyte range, and in case the client is connected to the network only through, for example, a low bandwidth telecommunication line or wireless communication link, the amount of time required for retrieving and visualizing a document may be long. Requested data would be transmitted to the client through the low bandwidth link to the client and thereafter transmitted to the dedicated site for further processing. After further processing at the dedicated site, resultant data in a format that may be interpreted or visualized by the browser at the client would then be transmitted back to the client.

Therefore, the above solution has the disadvantage of requiring the transmission of large amounts of data to and from the client. In case the client is connected to the network only through a low bandwidth communication link, retrieving and visualizing a document may require substantial time, which is clearly undesirable.

### SUMMARY OF THE INVENTION

It is therefore desirable to provide an access system and method for allowing retrieving and handling data in a network at reduced communication load.

The invention for example permits a reduced communication load in a client and server scenario by providing a proxy and remote handling of requested data on behalf of a client at a server instead of directly transmitting the requested data to the client.

According to an embodiment of the invention, a system for accessing data stored at a remote host in a computer network comprises a proxy server having a code section including instructions for receiving a request for data from a client. The proxy server further comprises a code section including instructions for making a determination whether the requested data should be rendered before transmission to the client. According to this embodiment of the invention, the system further comprises a processing server coupled to the proxy server and having a code section including instructions for receiving the rendering determination from the proxy server, rendering the requested data, and transmitting the rendered data to the client.

For example, by providing a proxy server for receiving a request for data from a client and by remotely rendering requested data at a processing server, embodiments of the invention permit significant reductions in the communication load transmitted to the client. Thus, embodiments of the invention reduce latency, particularly in case of a low bandwidth connection between the client and a network of data servers. In case rendering of data is determined to be necessary, the requested data may be rendered remotely at the processing server. Only rendered data, e.g. for visualization at the client, may be transmitted to the client.

In a further embodiment, the requested data may be retrieved from a data server and intermediately stored in a memory or intermediate data store upon the proxy server determining that data specified in the data request should be rendered. Likewise, the processing server may be further arranged for retrieving the data stored in the memory.

In a further embodiment, the proxy server may include a code section containing instructions for transmitting address information to the processing server, wherein the address information corresponds to a storage location of the requested data at a data server. The processing server in this embodiment may also include a code section containing instructions for retrieving the requested data from the data server.

The proxy server may further comprise a code section containing instructions for generating a link message containing address information corresponding to the requested data, as well as a code section containing instructions for transmitting the link message to the client.

The link message may further include data type information describing the requested data. The link message may also comprise a client identifier and a session identifier. The address information of the requested data may further comprise a Uniform Resource Locator (URL) and the data type information may comprise a Multipurpose Internet Mail Extension (MIME) type.

The proxy server may further include a code section containing instructions for directly transmitting the requested data to the client upon the proxy server determining that data specified in the request do not have to be rendered before transmission to the client.

At least the proxy server, the processing server, and the intermediate data store may be connected by a local area network, by a wide area network, or a combination thereof.

Further, a plurality of processing servers may be provided. The proxy server may be arranged to receive data requests from a plurality of clients, and to retrieve data specified in the data requests from a plurality of data servers. As described above, the proxy server may make a determination whether the retrieved data should be rendered before transmission to the client. If the proxy server determines that the retrieved data should be rendered, the proxy server may determine or select at least one processing server to render the retrieved data.

The processing server selected to render the retrieved data may then directly transmit the rendered data to the client or on a return path including the proxy server.

In one embodiment of the invention, the proxy server and the processing server may comprise a single data processing device.

In one embodiment of the invention, a client may comprise an analyzer module to receive and analyze a link message from an access system. A client may also include a data handler or a code section containing instructions for establishing a communication link between the client and the processing server and for receiving and handling rendered data from the processing server.

A client may also comprise a pre-selection module or a code section containing instructions for performing a pre-selection of requests for data into requests requiring rendering of data and requests that do not require rendering of data. The pre-selection module may also include instructions for transmitting requests requiring rendering to the proxy server, and for directly retrieving data in case it is determined that the requested data do not require rendering before transmission to the client.

Particular and preferred aspects of the invention are set out in the accompanying independent and dependent claims. Combinations of features from the dependent claims may be combined with features of the independent claims as appropriate and not merely as explicitly set out in the claims.

### BRIEF DESCRIPTION OF THE DRAWINGS

Exemplary embodiments of the present invention will be described hereinafter, by way of example only, with reference to the accompanying drawings in which like reference signs relate to like elements and in which:

FIG. 1 shows a block diagram illustrating an access system used in an embodiment of the invention;

FIG. 2 shows a process flow diagram of one embodiment of a method for processing a data request from a client in the system shown in FIG. 1;

FIG. 3A shows a process flow diagram further describing the embodiment of a method of processing a data request from a client as shown in FIG. 2;

FIG. 3B shows a process flow diagram further describing the embodiment of a method of processing a data request from a client as shown in FIG. 2;

FIG. 4 shows a block diagram illustrating an access system according to another embodiment of the invention;

FIG. 5 shows a block diagram illustrating an access system according to yet another embodiment of the invention;

FIG. 6 shows a process flow diagram of one embodiment of processing a data request from a client in the system shown in FIG. 5;

FIG. 7 shows a flow diagram illustrating a sequence of messages transmitted in the system shown in FIG. 5;

FIG. 8 shows a flow diagram illustrating a sequence of messages transmitted in accordance in the system shown in FIG. 5; and

FIG. 9 shows a block diagram illustrating an access system according to one embodiment of the invention.

In the drawings and the following detailed description, elements with the same reference numeral are the same element.

### DETAILED DESCRIPTION

Exemplary embodiments of the present invention are described in the following with reference to the accompanying drawings.

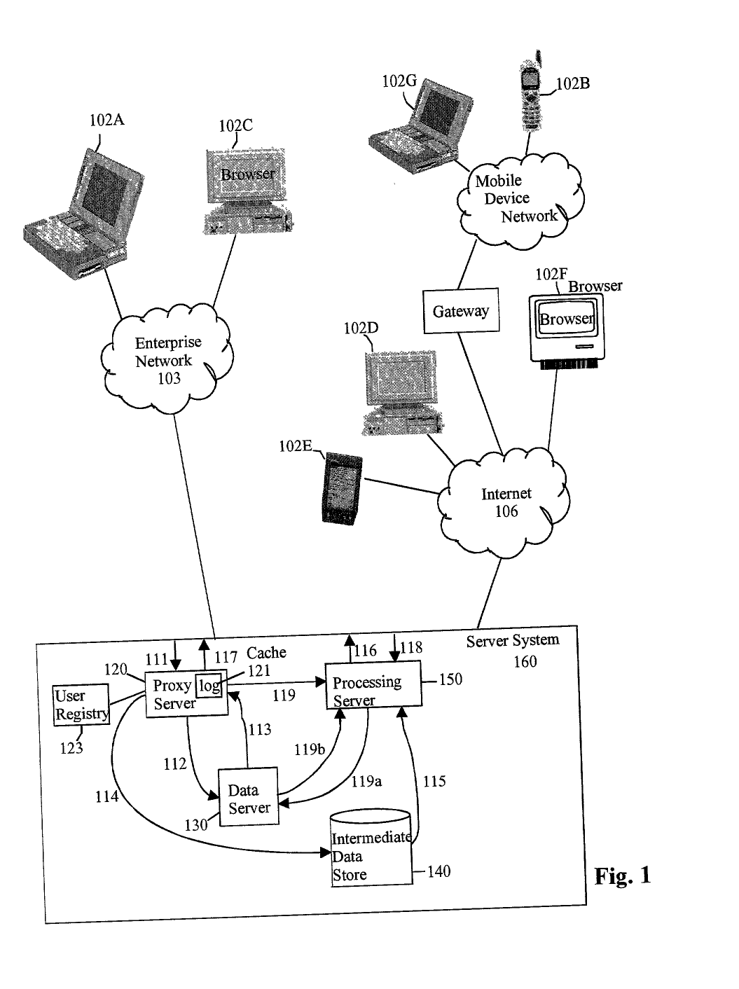

In the following a first embodiment of the invention will be described with respect to FIG. 1. FIG. 1 shows a schematic block diagram of an access system and a client for accessing data in a network according to an embodiment of the invention.

According to one embodiment of the present invention, a user can access the user's data or other data of interest to and available to the user from any one of a plurality of user devices 102A through 102F. When a first computer program executing on a user device, e.g. device 102A, issues a request for data, in response to a user input, the request may be received and processed by a second computer program, e.g. proxy server 120, executing on another computer system, e.g. server system 160. Alternatively, the request may be received and processed by a second computer program executing on the user device. In an embodiment of the invention described with respect to FIG. 1, server system 160 comprises a proxy server 120, a data server 130, an intermediate data store 140, and a processing server 150.

The access system of FIG. 1, for example, permits the reduction of a communication load in a client and server scenario by providing the proxy server 120 as a proxy for network clients 102A through 102F, and by providing remote rendering of requested data on behalf of the client at the processing server 150. Instead of directly transmitting the requested data to the client, only a rendering result may be transmitted to the network client 102A through 102F.

In the following the parts of the embodiment shown in FIG. 1 will be described in further detail.

Hence, with server system 160, a user can access data on Internet 106 and/or enterprise network 103 from almost any available client device, e.g., any one of portable computer 102A, a mobile telephone 102B, a workstation 102C, a home personal computer (PC) 102D, a personal digital assistant 102E, or an Internet café machine 102F. Client device 102A through 102F may be a general purpose data processing device, a mobile terminal such as a mobile computing device, a mobile phone or a mobile data organizer operated by a user wishing to access data stored remote from the client 102A through 102F at the data server 130.

No longer is a user limited to using a particular device with pre-installed software to access data with a particular format, or limited to using special devices, which support all capabilities needed to process the whole document. Rendering or processing of portions of a data file requested by a user may be accomplished by server system 160 and transmitted to client device 102A through 102F.

As a further example, consider that a user taps an icon displayed on PDA 102E to generate a data request for a sales report that is stored in a database in enterprise network 103. The data request is sent over Internet 106 to server system 160, that in turn, retrieves the data file containing the sales report, renders the data in the data file into a template and/or format that can be displayed on PDA 102E, and transmits the converted sales report to be displayed on PDA 102E. A similar transaction could be done using Internet cafe machine 102F, or perhaps mobile telephone 102D.

Plurality of devices 102A to 102F is illustrative only and is not intended to limit the invention to the particular devices illustrated. The devices could also include, for example, a POTS (plain old telephone service) telephone, a pager, a set-top box connected to a television, a network appliance, or any other device that is connectable to a network and can issue a request for data, as described more completely below, and display the data in response to the request.

In one embodiment, a request from a user device 102i, where user device 102i can be any one of the plurality of user devices 102A to 102F, specifies (i) a suitable address to the location where the content associated with the request is stored, for example, an address in the form of a uniform resource locator (URL), and (ii) information concerning the device type, the types of data that can be processed and displayed by user device 102i, e.g. MIME types, or alternatively applications available on the device to process and display data.

Enterprise network 103 is illustrative only of one embodiment of a network. The particular type of network connecting a user device 102i to server system 160 is not essential, and may be the Internet or any other permanent or temporary network, for example a local area network.

The data server 130 may be a data processing device with a large memory for storing data. The data server may be connected to a network, e.g. a public network such as the Internet, and therefore data stored at the data server will be accessible from the outside, e.g. through the Internet. For simplicity reasons, only one data server is illustrated in FIG. 1 as part of server system 160; however, it is understood that an arbitrary number of data servers at arbitrary locations may be provided.

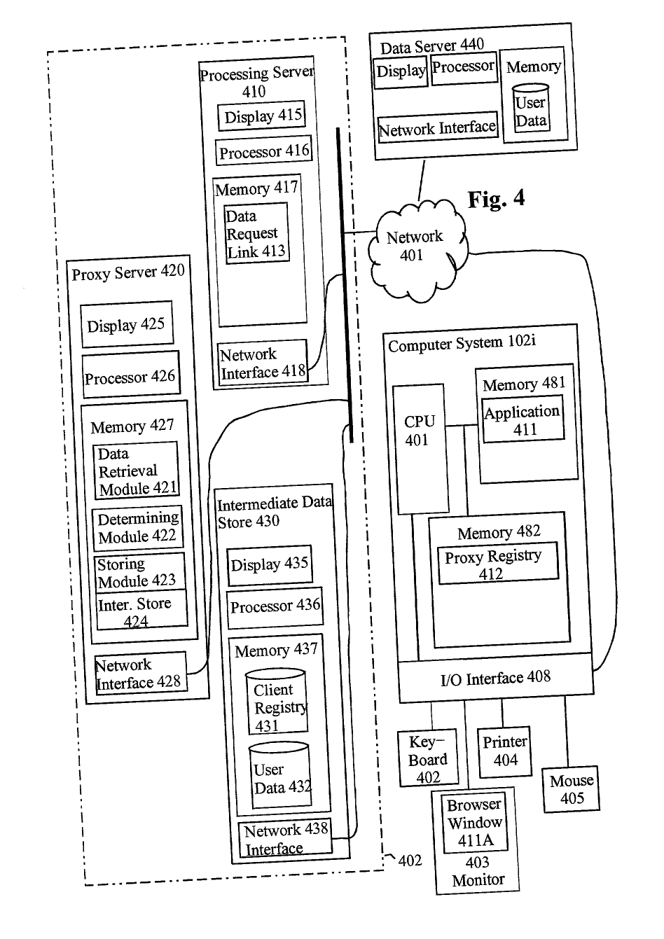

Further, the proxy server 120 may comprise a data processing device with large capacity for serving large numbers of client requests and may be registered at the client as a proxy. A proxy generally may be an agent authorized to act for another, e.g. in a communication with another data processing device, for example in the process of retrieving requested data. In the present case, therefore, the proxy server 120 is authorized to act on behalf of the client in retrieving data. Further, the proxy server may utilize information included in the client data request to determine whether a rendering, i.e. further processing or rewriting of the data is necessary before transmission to the client. Rendering may for example be desired in case the client does not have the necessary software tools to visualize the requested data. Rendering may also be used when it is determined that the requested data should not be directly handled by the client itself in order to reduce total processing time for the requested data. Finally, rendering may be used in dependence on an application associated with the requested data or a type of operation to be performed with the requested data, as it will be outlined in further detail, for example with respect to FIG. 4.

The intermediate data store 140 may for example be a single memory device or a data base system including a plurality of individual memories and may be used by the proxy server 120 for intermediately storing data, e.g. retrieved from the data server 130.

The processing server 150 may comprise a data processing device with large capacity to serve a large number of client requests, e.g. by rendering requested data for the client 102i, for example by running an application controlled via instruction from client 102i. The rendering operations performed by the processing server may include any processing or conversion operations to be executed on behalf of the client, for example converting data formats, rearranging data, providing selected parts of a data file for visualization, and the like, as it will be outlined in further detail, e.g. with respect to FIG. 4.

In the following, data transmissions in the embodiment of FIG. 1 will be described in further detail.

In the embodiment shown in FIG. 1, at least selected requests for data generated at the client 102i are not directly executed at the client 102i, but instead transmitted to the proxy server 120, as illustrated by the arrow 111. For example, client 102E, the PDA, may issue a data request to view and edit a spreadsheet data file. In such a case, a command to view and edit a spreadsheet data file, that is normally viewed on a personal computer, e.g. workstation 102D or personal computer (PC) 102C, will be transmitted to proxy server 120 for rendering into a format or template suitable for display on a PDA.

The proxy server 120 transmits a request for the requested data on behalf of the client 102i to an appropriate location, in the shown embodiment data server 130, as illustrated by the arrow 112. The data server in response thereto transmits the requested data to the proxy server 120, illustrated by the arrow 113. The transmissions may involve for example a network such as the World Wide Web on the Internet, or similar.

The proxy server 120 may utilize information regarding the client device to determine whether rendering is necessary. Such information may be provided by the client's data request or retrieved by the proxy server via a user registry 123 connected to the proxy server. In case at the proxy server it is determined that rendering is not necessary, the retrieved data may be directly transmitted to the client. In case the proxy server 120 determines that rendering is necessary, e.g. depending on client device type and/or client instructions, the data retrieved from the data server 130 may be buffered or temporarily stored in the intermediate data store 140, as illustrated by an arrow 114.

Thereafter the processing server 150 accesses buffered or intermediately stored data and retrieves the requested data, as illustrated by an arrow 115, and renders the requested data appropriately. The processing server 150 may be informed of the required rendering operations by the proxy server 120, e.g. based on a message containing information on required applications, data formats, and types of requests or instructions from the client. The information on the required rendering operations may be directly transmitted from the proxy server to the processing server. However, it is also possible that information on the required rendering operations is first transmitted from the proxy server 120 to the client 102i, as illustrated by an arrow 117, and then from the client to the processing server 150, as illustrated by an arrow 118.

However, it is noted that the data may be directly transmitted from the proxy server to the processing server as illustrated by an arrow 119, without being stored temporarily in the intermediate data store 140, for example in a real time scenario. In this case, the intermediate data store 140 is not required.

Thereafter the rendered data are transmitted to the client for further handling and/or for visualization purposes, as illustrated by an arrow 116. The rendered data may be constituted by screen contents for visualization, portions of documents or files for further processing such as editing, results of scientific calculations performed at the processing server 150, and similar.

It is noted that the processing server 150 may render the requested data interactively under control of the client, based on instructions from the client, e.g. in case a user wishes to scroll through a document or edit parts of a document.

Data transmission between the individual entities of the system shown in FIG. 1 may be accomplished via networks or dedicated communication links including wireless transmissions.

Further, it is noted that in case the proxy server 120, e.g. due to a previous request, already stored requested data in the intermediate data store 140, repeated retrieval of the same data files from a data server may be avoided by suitable measures. For example, a log 121 of retrieved data files, which may comprise a cache at the proxy server, may be accessed upon each new data request. Alternatively, proxy server 120 may check the intermediate data store 140 upon receiving a request.

It is further possible that the access sytem for accessing data in a network comprises a proxy server 120 arranged for receiving a data request from a client 102i and for determining whether the requested data have to be rendered before transmission to the client, and a processing server 150 arranged for rendering the data and for transmitting the rendered data to the client 102i.

Since proxy server 120 retrieves requested data on behalf of the client and the processing server 150 renders the requested data, the transmission of large amounts of data containing the originally requested data via communication links to and from the client can be avoided. Instead, only rendered data, or, when specifically requested, requested raw data, are transmitted to the client. Thus, the data transmitted to the client may potentially comprise only small amounts of data, e.g. screen content for visualization at the client data processing device 102i and similar. Thus, remote processing of requested data by the proxy server 120 and/or one or more processing servers 150 may not only format the data in an appropriate format for display on a variety of possible client devices, but can also reduce the data transmission bandwidth consumed for each transmission. This is particularly true in the case where a client device 102i communicates via low bandwidth connections, such as to and from a mobile terminal. Thus, the invention according to the above embodiments may be particularly useful for client devices accessing remotely located data via low bandwidth connections.

Still further, in case it can be determined whether rendering is necessary without retrieving the requested data, e.g. at the proxy server 120 or the client 102i, it is possible that the requested data are not at all or not fully retrieved by the proxy server, but only information on the location of the requested data is transmitted to the processing server 150, for example a URL, as indicated by an arrow 119. The processing server can then request and thereby retrieve the requested data from the data server 130 in preparation for rendering, as indicated by arrows 119a and 119b.

In this case, the proxy server 120 may retrieve some of the requested data, for example a part of the requested data including data type information, until a decision on rendering is possible and then stop retrieving the requested data. The already retrieved portion of the data may then be discarded. The intermediate data store 140 is not necessary in this case.

It is also possible that the client, upon generating a request, directly accesses the processing server 150 in arrow 118, for instructing the processing server to retrieve and render the requested data. In all cases, the client defines the data request to be made and then determines whether to send the request to the proxy server 120 or to the processing server.

It is noted that a computer readable medium may be provided, having a program embodied thereon, where the program is to make a computer or system of data processing devices execute functions of the above described elements, particularly of the proxy server and the processing server. A computer readable medium can be a magnetic or optical or other tangible medium on which a program is recorded, but can also be a signal, e.g., analog or digital, electromagnetic or optical, in which the program is embodied for transmission.

Further, a computer program product may be provided comprising the computer readable medium.

The functions of the processing server 150 and the proxy server 120 may be realized by executing code sections on a single data processing device, or on separate and/or multiple data processing devices. This data processing device may execute still further functions, such as functions of a web server, or similar.

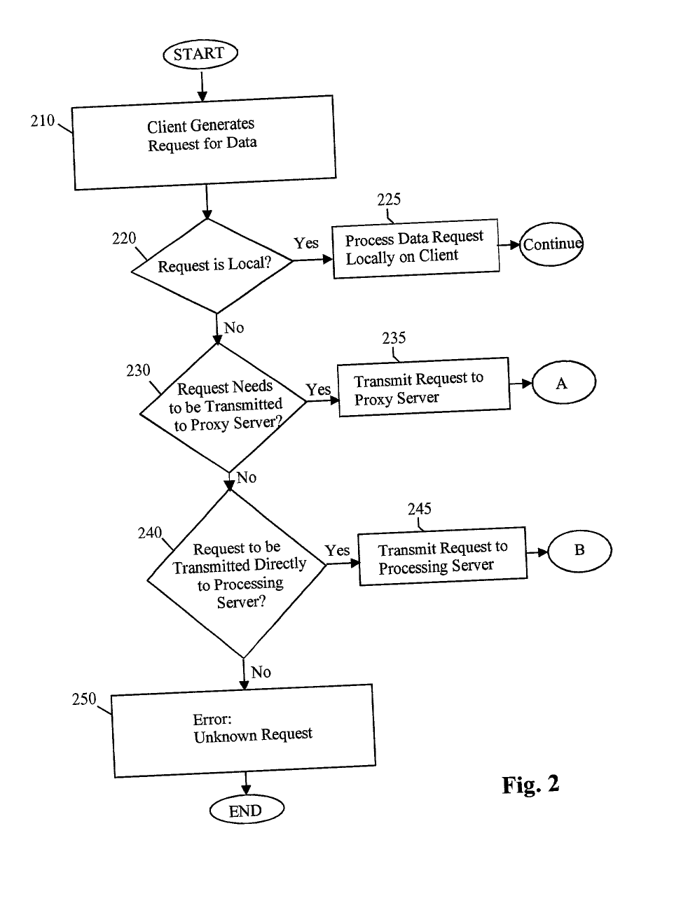

In the following a further embodiment of the invention will be described with respect to FIG. 2. FIG. 2 shows a process flow diagram of operations performed in the method according to an embodiment of the invention, e.g. in case a client wishes to access data in a network.

The processing operations may be performed at the embodiment of the access system described with respect to FIG. 1; however, the processing operations are not limited thereto.

In a first operation 210 a client, e.g. client data processing device 102i of FIG. 1 generates a client data request. The client data processing device 102i then determines how to process the data request. If, as shown in operation 220, the client data processing device decides to locally process the request, e.g. for data that resides locally on the client machine, the client will then proceed to process the data request locally on the client device as shown in operation 225.

If the data request is not to be locally processed, e.g. for data that is located remotely at a data server 130, the client data processing device determines whether the request needs to be transmitted to a proxy server in operation 230. If so, the client device transmits the data request to the proxy server in operation 235. If not, the client may proceed to determine whether the request should be directly transmitted to the processing server in operation 240. Note that if the client directly transmits the request to the processing server in operation 245, the client designates a processing server in the data request. In one embodiment of the invention, if the request is not directly transmitted to the processing server in operation 240, and the data request is an unknown request, an error will result, as shown in operation 250.

As discussed above, the client may be configured to transmit all requests to the proxy server or only selected requests, e.g. selected in accordance with a type of request, type of data requested, data file sizes or similar. The proxy server retrieves the requested data from a data server which may be accessible though a network of data processing devices such as a local area network or a wide area network. It is noted that the proxy server may omit the operation of retrieving the requested data, in case the data were already retrieved at an earlier point in time and are locally available, for example, stored in log or cache 121 included in the proxy server.

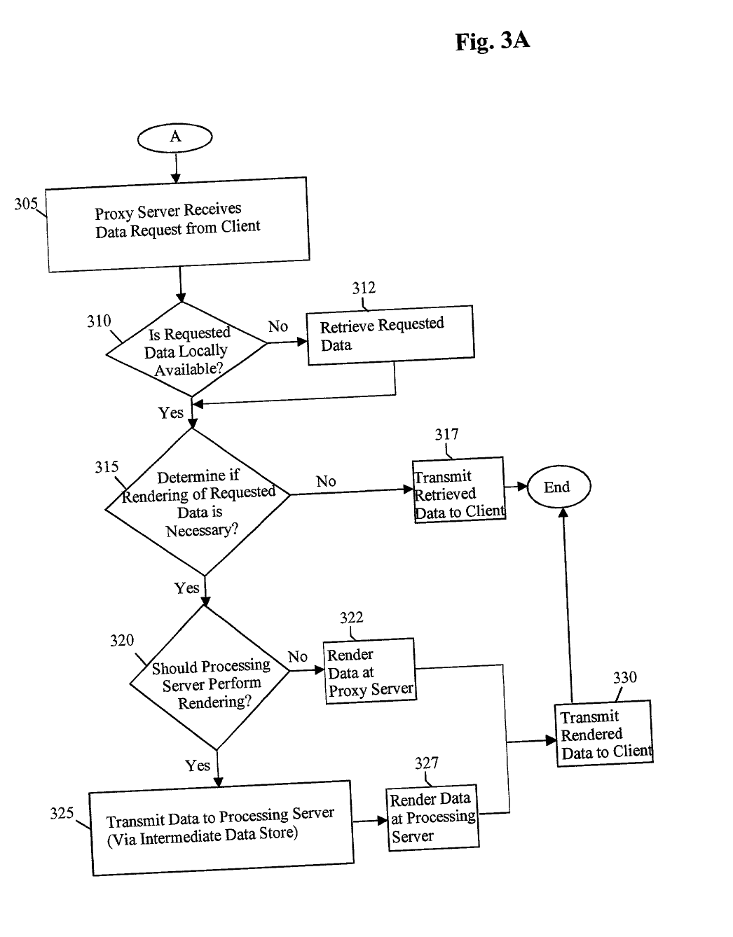

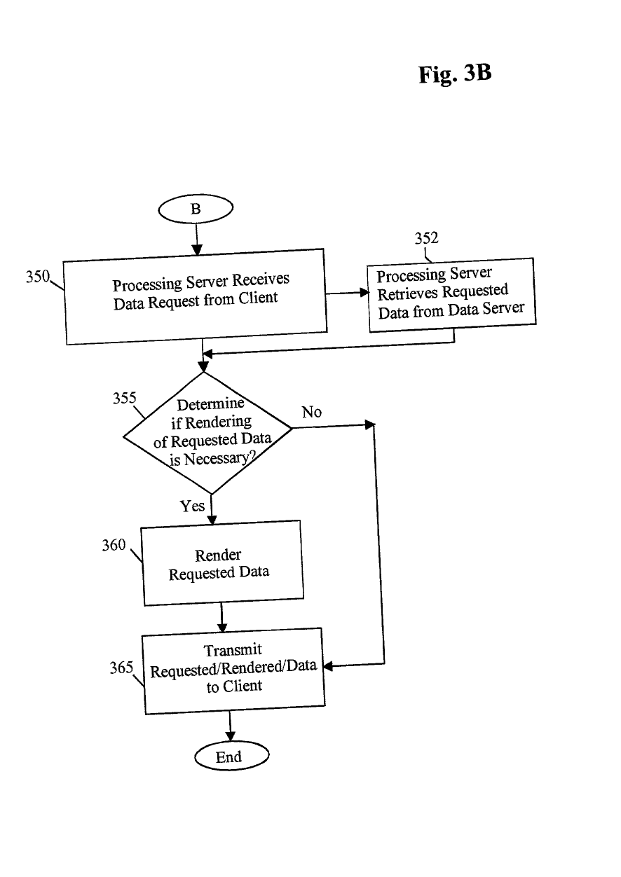

FIG. 3A shows a process flow diagram depicting a sequence of operations in an embodiment of the present invention when a proxy server receives and processes a data request from a client. The process shown in FIG. 3A follows operation 235 in FIG. 2. In operation 305, the proxy server receives the data request sent by the client. In operation 310, the proxy server determines whether the requested data is locally available on the proxy server, e.g. via log or cache 121 shown in FIG. 1. If not, in operation 312 the proxy server retrieves the requested data from a data server before determining if the requested data should be rendered in operation 315. If so, the proxy server will proceed directly to the rendering determination in operation 315.

If rendering the requested data is not determined to be necessary, the requested data, retrieved by the proxy server, is transmitted to the client in operation 317. If rendering is determined to be necessary, the proxy server then determines in operation 320 whether the processing server should perform the rendering. If not, the retrieved data is rendered directly at the proxy server in operation 322 and the rendered data is transmitted to the client device in operation 330. If so, the retrieved data may be transmitted to the processing server by the proxy server in operation 325.

In one embodiment of the present invention, the data to be transmitted in operation 325 may be temporarily stored in intermediate data storage 140. Thereafter, the temporarily stored data may be retrieved by the processing server and rendered appropriately, as shown in operation 327. After rendering, the flow of processing operations continues as described above in operation 330, as the rendered data is transmitted to the client device. Alternatively, the proxy server transmits the data directly to the processing server in operation 325.

It is noted that the sequence of operations may be varied, e.g. operation 315 may be executed before or concurrently with operation 312, as it may already be determined whether rendering is necessary before the requested data are retrieved. Varying the sequence of operations in this manner permits multi-threading of operations. For example, a proxy server receiving a data request could issue a retrieve request immediately, and then, while waiting for the retrieve request to complete, could determine whether rendering is necessary.

FIG. 3B shows a process flow diagram depicting a sequence of operations in an embodiment of the present invention when a processing server receives and processes a data request from a client. The process shown in FIG. 3A follows operation 245 in FIG. 2. In operation 350, the processing server receives the data request from the client device. The processing server then retrieves the requested data from the data server in operation 352, or from some other storage location, for example if the requested data is stored locally on the processing server. The processing server then determines, in operation 355, if the requested data should be rendered. If so, the requested data is rendered in operation 360 and then transmitted to the client in operation 365. If not, the processing server then transmits the requested data directly to the client in operation 365.

According to the above processing operations, in case rendering is required, data requested by the client are not directly transmitted to the client but are instead handled first by the processing server and the proxy server. Only rendering results are transmitted to the client. This helps reduce network latency problems.

It is noted that all processing operations described above may be realized by code sections for execution on a data processing system.

As in the embodiment described with respect to FIG. 1, the access system according to the embodiment of the invention shown in FIG. 4 allows to reduce a communication load in a client and server scenario. The reduction in communication load, and concurrent optimisation of data display, occurs by providing a proxy and remote handling of requested data on behalf of the client instead of transmitting the requested data to the client as will be outlined in the following.

Further to the features shown in FIG. 1, the embodiment of the present invention shown in FIG. 4 illustrates a local area network 402 and a wide area network 401. A client data processing device 102i includes an application program 411, e.g. a browser program. Further, FIG. 4 shows a processing server 410, an intermediate data store 430 and a proxy server 420 including retrieving module 421, determining module 422, and storing module 423.

In the following the features shown in FIG. 4 will be outlined in further detail.

In FIG. 4, the proxy server 420, the processing server 430, and the intermediate data store 430 are connected through the local area network 402. The local area network 402 may be a single, company wide network or similar, but is not limited thereto. For example, local area network 402 may also comprise a number of mutually connected individual networks.

Further, in FIG. 4, the local area network 402, the client 102i and the data server 440 are shown as connected via the wide area network 401, e.g. a public network such as the Internet. In this case, data are exchanged between the local area network 402, the client 102i, and the data server 440 via the wide area network 401. However, it is also possible that communication links between the client 102i, the local area network 402, and the data server 440 are realized using dedicated lines of a telephone network or similar, including wireless communication links.

However, it is also conceivable that the entire system is located in a wide area network. In such a situation, it is possible that the proxy server 420, the intermediate data store 430 and the processing server 410, as well as the data server 440 are part of the local area network 402, accessed from the outside by the client 102i. In yet another scenario, it is possible that all components of the system are part of a local area network.

As discussed above and with respect to FIG. 1, the client 102i may comprise a general purpose data processing device, such as a personal computer. Client 102i may be operated by a user who for example wishes to access information available on data server 440 remote from the client, such as text documents, images, movie clips, audio data and similar. The client may also comprise a mobile terminal such as a mobile computing device, a mobile phone, or mobile data organizer.

For accessing the desired information the client 102i may be provided with software, e.g. application 411, that may be loaded in memory 481, and when executed on CPU 401 permits browsing information or transmitting data in data communication networks. In FIG. 4, a browser window 411A for browsing information or transmitting data in a data communication network is displayed on monitor 403 during execution of application 411. Generally, a browser may comprise a piece of software which, when run at the client, allows a user to browse through a set of data, i.e. a program that may serve as a front end to the World Wide Web on the Internet. In this case, a user may enter an address of a web site into the browser's location field and a corresponding home page will be downloaded for local display. The downloaded information may, if visualized, serve as an index to other pages on the web site that can be accessed by clicking for example on a “click here” message, high-lighted text, or an icon on the screen.

The client 102i may be connected to the wide area network 401 via I/O interface 408, for example the Internet, or may be connected to any other network or may be directly linked to the local area network 402, for example a company-wide intranet. In both cases, the client may be connected via a standard telephone line, ISDN, by a wireless connection, or similar. I/O interface 408 may also be connected to keyboard 402, monitor 403, printer 404, and mouse input device 405.

The client 102i preferably sends requests to the proxy server 420. This may be accomplished by registering the proxy server 420 at the client 102i as a proxy, e.g. using a proxy registry 412, which may in one embodiment comprise a data structure stored in a memory of client device 102i, e.g. memory 482.

For example, an application may provide an option to register another device as a proxy by entering a network address and a port number into a specified location on a display, e.g. at a client, and storing this address and port number in a memory of the client as specified above.

As outlined before, a proxy may in general be realized as a software application that may for example run on a dedicated server that executes requests from a client entity on behalf of the client. Thus, in general a request from a client entity is routed through the proxy entity, which retrieves the requested information and transmits it to the client entity. However, as discussed above, particularly with respect to FIG. 2, it is also possible that the client 102i only sends selected requests to the proxy server 420. In such an embodiment of the invention, the proxy server is registered at the client as a proxy only for selected requests, e.g. requests concerning certain documents, applications or data types or requests that require rendering. All other requests may be directly executed by the client 102i (or otherwise directly handled by a client, e.g. directly transmitted to a processing server) without being routed through the proxy server 420. Registration as a proxy may depend on the site to be accessed, e.g. be domain dependent. Thus, domains known to contain data requiring rendering would be accessed through the proxy server, whereas other domains could be accessed directly.

The request for data from the client 102i may be in a standard format, e.g. as used in packet switched networks. A request may, for example, include a URL or a desired document.

The proxy server 420 in the embodiment of FIG. 4 comprises retrieval manager, e.g. a retriever or a code section containing instructions for retrieving the requested data from data server 440 upon receiving the request for data from the client 102i. Preferably this involves sending a request from the proxy server 420 to the data server 440. The data server then obtains the requested data from its memory and transfers the requested data back to the proxy server 420. As before, the data server 440 may be any server of a public network, such as the Internet, or may be a server of a local area network, such as a company-wide intranet. The retrieval manage may thus comprise a programmed data processing unit or may alternatively be realized in hardware.

Rendering may for example be needed in case the client does not have the necessary software tools to visualize the requested data. Information on software tools available at the client may for example be transmitted from the client to the proxy server with the data request or may be provided with client specific information available at the proxy server. For example, client specific information specifying browser capabilities or software tools available at the client could be stored beforehand in a client file in a memory which is accessible from the proxy server. The client specific information could be generated at the time when the client logs onto the proxy server, e.g. via transmission from the client to the proxy server. The proxy server, upon receiving the client specific information, could store this client specific information in a client registry. The client registry may be stored in a memory accessible to the proxy server, e.g. as client registry 431 in a memory of a data server accessible to the proxy server, e.g. memory 437 of intermediate data store 430. Upon receiving a data request from a client, the proxy server could retrieve and analyse that client's file from the client registry. The result of the proxy server's analysis, which in one embodiment of the invention may be performed by the determining module 422, could be used to determine if rendering of the data requested by the client is required.

The client specific information stored in a client file at the client registry 431 could also include user preferences configured beforehand at the client, specifying cases where rendering is desired.

Further, rendering may also be required in case it is determined that the requested data should not be directly handled by the client itself. For example, a rendering determination could be made in dependence on a file size of the requested data. This is because large file sizes may introduce high latency, particularly in a case where the client is connected to the network through a low bandwidth communication link and/or in case the client has a low capacity central processing unit. For example, rendering could be decided to be necessary in case the client is communicating through a low bandwidth communication link such as a standard telephone line or a wireless link, and requests concerning documents with a file size larger than, e.g. 1 Mbyte are received at a proxy server.

Further, rendering could be decided to be necessary in case a request has high processing demand and the client is comprised of, e.g. a small size mobile device such as a mobile phone or a mobile organizer with limited processing capabilities.

Rendering may also be required in dependence on an application associated with the requested data or the type of operation to be performed with the requested data. For example, rendering may be utilized when a small part of a bitmap image is to be visualized at the client or in case only selected pages of a large document are to be displayed at the client, e.g. for scrolling through a document or for editing part of a document.

It is noted that it is also possible that information whether rendering is desired is transmitted with the request for data from the client, e.g. contained in a URL. For example, it may be determined based on a data request from a client whether a document should be opened locally, i.e. without rendering, or whether the document should be rendered, i.e. handled remotely, and only data frames for display should be transmitted to the client. In this case, the determining module 422 analyses the request from the client in order to determine whether rendering is necessary.

It is further noted that the decision on rendering may in some cases be reached by the determining module 422 in the proxy server without retrieving the requested data at all, or retrieving only part of the requested data. In such a case, the rendering determination may be made based on information contained in the data request from the client. Alternatively, the rendering decision may be made based on header information included in the transmission of the requested data from a data server.

In case the determining module 422 concludes that the request received from the client 102i does not require any rendering operations, i.e. further processing or rewriting of data, the proxy server 420 may directly transmit the requested data to the client device 102i. However, it is also noted that in this case the proxy server may perform operations on the requested data, e.g. format conversions or similar. Format conversions of a document or data file from a first arbitrary known format to a second arbitrary known format are disclosed in copending and commonly assigned U.S. patent application Ser. No. 09/759,042, entitled “A METHOD AND STRUCTURE FOR DYNAMIC CONVERSION OF DATA”, filed Jan. 12, 2001, herein incorporated by reference.

In case it is determined that the requested data need to be rendered before transmission to the client, storing module 423 at the proxy server may be used to store the requested data in intermediate memory store 430. The storing module 423 may be implemented by code executing on a data processing device, e.g. processor 426 running on proxy server 420, or may also be realized in hardware. The intermediate data store 430 may for example be a local data base for storing and handling different types of content information or any other memory. The intermediate data store can be directly connected to the proxy server, e.g. as a segment 424 of memory 437, or can be accessible to the proxy server via local area network 402 (e.g. intermediate data storage server 430).

The processing server 410 preferably comprises a data processing device with high capacity, e.g. a high level of processing capability in processor 416. In one embodiment of the invention, processing server 410 has the resources for further rendering the requested data temporarily stored in intermediate data store 430. The rendered data may then be transmitted to the client by the processing server. The processing server 410 is in communication with the intermediate data store 430, retrieves the data temporarily stored in the intermediate data store 430, and performs the needed operations for rendering.

As mentioned above, the rendering at the processing server 410 may, for example, include converting data formats. For example, rendering operations at the processing server 410 may be performed in order to convert a requested document into a format which can be handled at the client, depending on the processing and visualization capabilities of the browser or other application program at the client device. For example, the request from the client may be related to a document that may not be directly visualized at the client. In this case, the processing server 410 may invoke an application for converting the document into a format which may be visualized at the client, for example, an HTML document or bitmap image. This may involve communication between the client and the processing server based on a bitmap protocol or X Windows protocol.

Rendering may also include rewriting contents when dynamically generating web pages. If for example only a part of a document is to be visualized at the client for reading or editing purposes, the processing server 410 may perform one or more processing operations to provide the client with the requested parts of the document. Further, the processing server 410 may receive an edited portion of a document from the client 102i and perform processing operations to introduce the edited portion of the document back into the original file for storing purposes. This is particularly useful in case the client and the processing server are involved in an interactive session for manipulating data, wherein the data reside at the processing server 410 and are manipulated via instructions from the client.

The information on the required rendering operations may be transmitted from the proxy server 420 to the processing server 410. However, it is also possible that information on the required rendering operations are first transmitted from the proxy server 420 to the client 102i and then used by the client to generate a message for transmission to the processing server 410. The message may include, in one embodiment of the invention, an identifier or address to access the requested data, and/or information on communication protocols and/or data types and similar.

After rendering, the requested data are transferred from the processing server 410 to the client 102i for further handling or visualization.

Communication between the client 102i and the processing server 410 may include a bitmap protocol or X Windows protocol or similar. This may involve establishing a bi-directional connection between the client and the processing server, allowing the transmission of a sequence of rendering instructions from the client to the processing server in an interactive session. Such an interactive session may include scrolling through a document or for editing purposes or for displaying parts of image data such as a bitmap.

Transmission of data from the processing server 410 to the client 102i may be accomplished via a direct connection, e.g. through a packet switched network connections, and may also involve a wireless communication link.

It is noted that the processing server 410 may also be arranged to transmit the rendered data to the client on a return path including the proxy server, such that the client receives the rendered data via a connection established between the client and the proxy server.

It is further noted that the functionalities of the processing server 410, the proxy server 420, and the intermediate data store 430 may be realized by executing code sections on one or more data processing devices and all required data transmissions, specifically between the processing server, the intermediate data store and the proxy server, and may be handled via local buses or network connections.

Further, the above embodiment may be used to allow access to services not directly “visible” at the client, e.g. accessible through URLs not known at the client. These may be services of a particular local area network, intranet, or similar. In this case, it is possible to rewrite access information of the services not known at the client, e.g. the URLs, such the client transmits the corresponding request to the proxy server. The rewriting could be performed at the server or at the client, provided that information on the specific services to be requested from the proxy server are accessible at the server or client.

In the described scenario, generally the link to the client may have low bandwidth due to a modem connection or similar, whereas the transmission links between the proxy server, the intermediate data store, the processing server and the data server will likely have high throughput. Since requested data may be rendered at the processing server, and only rendering results, e.g. frames for local display at the client are transmitted to the client, the system will introduce low latency even in the cases where large size documents are to be handled. Thus, the invention according to the above embodiment allows the reduction of band width requirements, to reduce latency and allows access to resources in an intranet not directly visible from a client.

Still further, in case it can be determined whether rendering is necessary without retrieving the requested data, e.g. at the proxy server or the client, it is possible that the requested data are not all or not fully retrieved by the proxy server. In such a case, only information on the location of the requested data may be transmitted to the processing server 410, for example a URL, included in data request link 413. The processing server can then retrieve the requested data from the data server specified in the link in preparation for rendering.

In this case the proxy server may retrieve some of the requested data, for example a part of the requested data including data type information. The proxy server may continue retrieving data in an embodiment of the invention until a decision on rendering is possible, at which time the proxy server may stop retrieving the requested data. The already retrieved data may then be discarded. The intermediate data store 430 is not needed in this case.

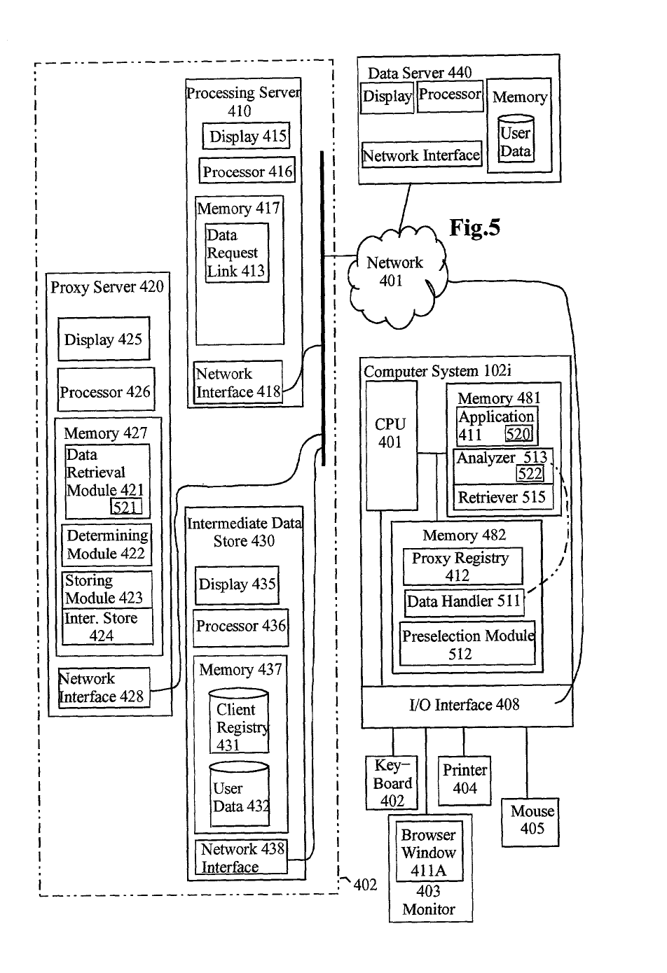

In the following, a further embodiment of the invention will be described with respect to FIG. 5. FIG. 5 shows a schematic block diagram of an access system for accessing data in a network according to another embodiment of the invention.

The embodiment of the invention shown in FIG. 5 is similar to the embodiment shown with respect to FIG. 4; however, the requested data, after being temporarily stored in the intermediate data store, are rendered and transmitted to the client only upon request of the client.

FIG. 5 illustrates a client 102i including data handler 511 and pre-selection module 512. Connected to client 102i via wide area network 401 includes proxy server 420, a data server 440, an intermediate data store 430, and processing server 410.

In the embodiment of the invention shown in FIG. 5, a user at client 102i, which is executing application program 411, generates and transmits a data request 520 to the proxy server 420 during execution. In one embodiment of the invention, the data request contains a URL. The proxy server 420 then generates a dummy response or link message 521, e.g. in data retrieval module 421, wherein the link message instructs the client to redirect the data request to the processing server 410. This may be accomplished by a code section containing instructions executed at the proxy server or by dedicated hardware.

In one embodiment of the invention, the link message may include information on the storage location of the requested data, e.g. a URL or similar, specifying a storage location in the intermediate data store 430 wherein the requested data may be accessed. In another embodiment, the link message may include address information of the site responsible for further processing or rendering of the requested data, e.g. a URL or address for the processing server 410. The link message may also include information e.g. protocol specifications that may be used to establish a communication link between client 102i and processing server 410. Address information of the site responsible for rendering of the requested data is particularly useful, in case a plurality of processing servers is provided.

However, in another embodiment of the invention, client 102i may be separately configured to connect to a predetermined site upon receiving a link message, e.g. to the processing server 410. In this instance, the link message 521 does not need to contain address information of a site, responsible for rendering of the requested data.

In one embodiment of the invention, the link message 521 may further include information on required rendering operations and may include information on the data type or format of the requested data after rendering. Such information may be particularly important in the case where the data format will change during rendering, e.g. a MIME type.

The link message 521 may also include user information, e.g. a password for authentication purposes and/or session identifier (session ID). A session ID may be particularly useful in case the client previously generated a similar request for data, and the requested data has already been accessed and/or the processing server has already launched a process executing an application for rendering the requested data.

In one embodiment of the invention, the link message 521 will be transmitted from the proxy server 420 to the client 102i in place of, e.g., a transmission containing requested and/or rendered data. Client 102i thus receives from the proxy server a message indicating that the data may not be obtained from the proxy server 420 but from another site.

Upon receiving the link message 521 from the proxy server 420, the client 102i preferably analyses the link message at analyser module 513. Analyser module 513 then generates a corresponding request 522 for the processing server 410 concerning the requested data and transmits this request 522 to the processing server 410.

This request may specify the expected data, e.g. a URL, and/or data type information and/or information on execution of a particular protocol at the client.

In response to receiving the request from the client 102i, the processing server 410 preferably accesses the intermediate data store 430 and retrieves the requested data that was temporarily stored in data store 430 by proxy server 420, as described above. Then, after performing the required rendering operations, as outlined before in detail with respect to previous embodiments, the processing server 410 may transmit the rendered data to the client 102i for further handling and/or visualization purposes.

Upon receiving the link message 521 from the proxy server 420, analyser module 513 running at client 102i preferably activates a data handler 511, also running at client 102i. The data handler 511 may establish a communication link between the client 102i and the processing server 410, and may also contain code for further handling rendered and/or requested data received from processing server 410.

For example, in one embodiment of the invention, the data handler 511 may be realized by a hardware unit or by executing a code section containing instructions on a client data processing device 102i for establishing a communication link between the client and the processing server. Data handler 511 may also generate commands for execution by the processing servers to manipulate the requested data and/or to visualize or further process received information. The data handler 511 may include, e.g. a suitable plugin such as tools for page by page viewing, Active-X control, Java applets, or similar.

The data handler 511 may be started upon receiving link message 521 from the proxy server 420 and further, the link message may include information for allowing the data handler 511 to contact the processing server 410 in order to establish a communication link. When the communication link is established, the data handler 511 may instruct the processing server 410 to retrieve the requested data from the intermediate data store 430, if that has not already been done. Furthermore, the data handler may instruct the processing server to render the requested data as specified by application 411 executing on client 102i. For example, the processing server may render the requested data in a format to enable the user executing requesting application 411 to scroll through a user document. In another example, processing server 410 may render the requested data, e.g. by adding template elements to the requested data, in order to transmit content of a user document for editing purposes and similar. Upon receiving corresponding data from the processing server 410, the data handler 511 may activate a display at the client or initiate further handling of the data.

In one embodiment of the invention, more than one data handler 511 may be available at the client data processing device 102i. In such an embodiment, the data handler to be activated at the client may be determined by the proxy server 420 through information included into the link message.

As discussed above, in addition to application 411, the client may thus comprise an analyser 513 to receive and analyse data from the access system set forth in embodiments of the invention, including processing server 410, proxy server 420, intermediate data store 430, and data server 440. The analyser may then activate data handler 511 as needed to handle and process the rendered and/or requested data.

Further, as discussed above, the client may comprise a proxy registry 412 configured to record proxy server 420 at the client as a proxy, and a retriever 515 to retrieve the rendered data from the processing server 410. In one embodiment, the retriever 515 may be coupled to or included in analyser 513. Like application 411, analyser 513, data handler 511, retriever 515, and proxy registry 412 may be realized by a hardware unit or by a code section containing instructions for execution on a data processing device.

The client may also comprise pre-selection module 512, comprising a code section containing instructions, or a hardware implementation, configured to perform a pre-selection or partitioning of data requests into requests requiring rendering of data and requests not requiring rendering of data. Pre-selection module 512 may also transmit data requests requiring rendering operations to the proxy server 420. In one embodiment of the invention, pre-selection module 512 is configured to direct retriever 515 and analyser 513 to directly retrieve and process data, e.g. from data server 440 connected to wide area network 401, when it is determined that the data request does not require rendering before transmission to the client. The pre-selection module 512 may be located at the client and may also be realized by a hardware unit or by a code section containing instructions for execution on, e.g. CPU 101 of client data processing device 102i.

In one embodiment of the invention, the process of pre-selecting data requests at pre-selection module 512 may be based on one or more previously configured user preferences.

For example, user preferences may be set with respect to file sizes. For example, in the event that the client generates a data request concerning a document exceeding a predetermined size, the user may set a preference to render the data. For example, the user may set a preference so that only a portion of the document is initially rendered and transmitted to the client for display, or the entire document may be rendered, but in a more compactly, e.g. as text only. User preferences may also concern desired activities, such as scrolling through a document, editing parts of a document, and similar. Further, other user preferences may concern bandwidth of a communication link available at the client, processing capabilities at the client, or similar.

Still further, rendering determinations at the pre-selection module may depend on requested data types and the availability of processing tools at the client. The rendering determination may also be based on the fact that a domain to be accessed upon a request is part of a predetermined group of domain names, e.g. domains storing data that are known to require rendering.

As discussed above, in the event that pre-selection module 512 determines that rendering is not required, the client 102i, via, e.g. retriever 515, may directly access a data server, e.g. data server 440, to retrieve the requested data.

It is noted that all functionalities of the client, including pre-selection module 512, may be realized by executing code sections on a data processing device.

Still further, in case the proxy server can determine whether rendering is necessary without retrieving the requested data, it is possible that the requested data are not fully or not at all retrieved by proxy server 420. In this case, only information on the location of the requested data, e.g. a URL, is included in the link message for transmission to the client 102i. The client may then include information on the location of the requested data into the request for transmission to the processing server 410 concerning the requested data.

The processing server could then retrieve the requested data directly from the data server 410 in preparation for rendering. In this case, the requested data need not be transmitted to intermediate data store 430.

The proxy server may still retrieve at least some of the requested data, for example a part of the requested data including data type information, until a decision on rendering is possible and then stop retrieving the requested data. The already retrieved portion of the data may thereafter be discarded.

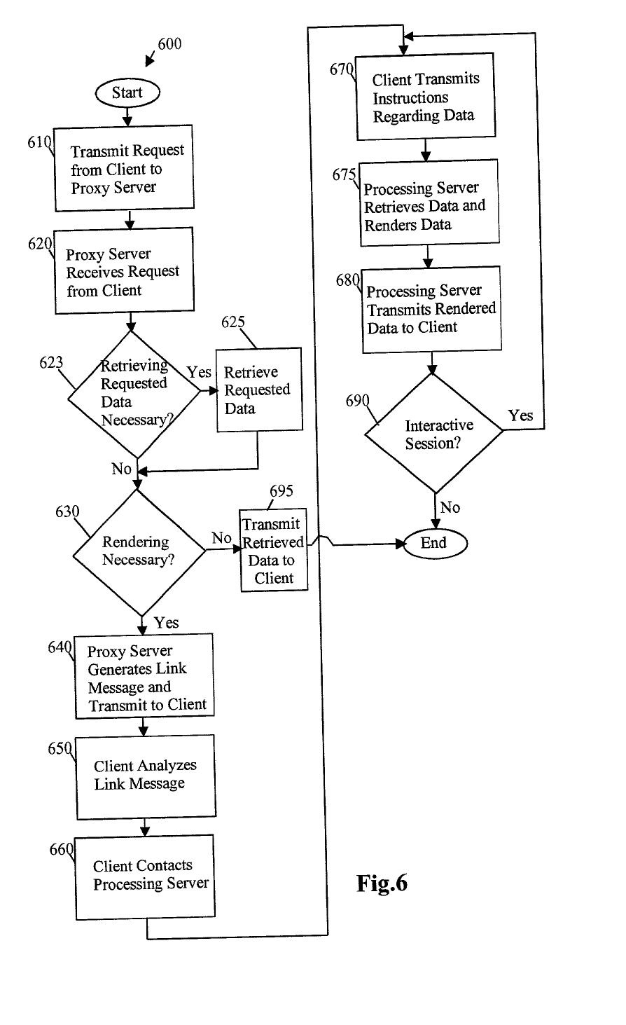

In the following a further embodiment of the invention will be described with respect to FIG. 6. FIG. 6 shows a process flow diagram of operations performed according to an embodiment of the invention, e.g. according to the embodiment outlined with respect to FIG. 5.

In a first operation 610 a client transmits a request to the proxy server. The data request from the client may be in a standard format, e.g. as used in packet switched networks. A request may, for example include a URL of a desired document, information on a client identity, a requested application, and similar.

In an operation 620 a proxy server receives a request for data from a client. In operation 623, the proxy server determines whether the requested data should be retrieved. If so, the requested data is retrieved in operation 625 from a data server, as outlined with respect to previous embodiments. It is noted that in case the requested data were already previously received from a data server and temporarily stored in the intermediate data store 430, the requested data do not have to be again retrieved from the data server. Instead, it can be determined at the proxy server using a log of client requests or by inquiring at the intermediate data store which data were already retrieved, reloading of data may be avoided. In this case download of requested data from the data server may be started but after retrieving information of the requested data from the data server, the download could be interrupted in case it is determined that the requested data are already stored in the intermediate data store.

Thereafter, in a operation 630 the proxy server determines whether rendering is necessary, e.g. based on the retrieved data, information on processing capabilities at the client or depending on a file size of the requested data, transmission bandwidth, processing bandwidth and similar, as outlined before.

In case rendering is determined not to be necessary, i.e. the decision in operation 630 is “NO”, the data may be directly transmitted to the client in operation 695 and the flow ends.

In case the proxy server determines that rendering is necessary, i.e. the decision in operation 630 is “YES”, in a operation 640 the proxy server generates a link message 521 and transmits the link message to the client. As outlined before, the link message may include address information of the requested data indicating a storage location in the temporary memory means, such as an URL. Further, the link message may specify a host for performing the rendering, preferably the processing server. Furthermore, the link message may contain information allowing the client to establish a communication link to the processing server and finally, the link message may contain a user identifier (user ID) and/or a session identifier (session ID) specifying a communication link to the processing server.

In a operation 650 the client receives and analyses the link message from the proxy server. In case the link message contains information on a protocol to be started in order to communicate with the processing server, corresponding software tools may be started at the client in order to contact the processing server. After establishing a communication link between the client and the processing server 410 in an operation 660, the client transmits instructions regarding the requested data to the processing server in operation 670.

In a operation 675 the processing server retrieves the requested data and renders the data, preferably according to the requests received from the client and in an operation 680 the processing server transmits the rendered data to the client.

In an operation 690 the processing server determines whether the client started an interactive session, e.g. whether the client wishes to control an application program running at the client.

In case the client started an interactive session the flow returns to operation 670 wherein the client transmits further instructions regarding the requested data. For example, in case the session concerns the visualization of a document including scrolling, further instructions from the client could relate to scrolling through the document. Further, in case parts of a document should be edited, further instructions could specify parts of a document to be edited. In this case, after editing the edited part of the document would be transmitted back from the client to the processing server and introduced into the document.

In case the client and processing server are not involved in an interactive session, the flow of processing operations ends.

It is noted that all processing operations described with respect to FIG. 6 may be realized by a program or code sections executed on a system of data processing devices.

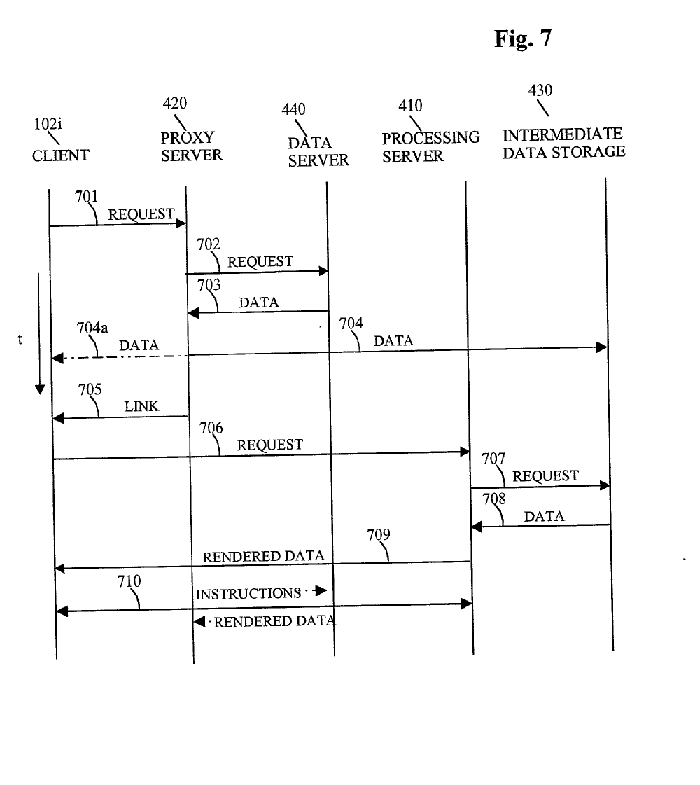

In the following a further embodiment of the invention will be described with respect to FIG. 7. FIG. 7 shows a flow of messages transmitted between the different entities of an access system according to an embodiment of the invention, as described in FIG. 5.

In FIG. 7, messages are transmitted between the client 102i, for example a client application or browser, the proxy server 420, the data server 440, the processing server 410 and the intermediate data store 430. The vertical lines indicate evolving time t in downward direction at each entity of the system.

In an operation 701, a request for data is generated at the client 102i and is transmitted to the proxy server 420. This request may, for example, include an URL concerning a “StarWriter” (.sdw) document, which is in a data format that is part of the “StarOffice” suite. The client may be involved in a direct communication with the proxy server or through a packet switched network, including wireless connections. In case of a packet switched network, the request may include a URL which may be translated by a DNS (directory network server) into an IP-address (Internet Protocol address) and a port number, e.g. port 80 for a HTTP (Hyper Text Transport Protocol) connection for an HTML (Hyper Text Markup Language) document.

The proxy server 420 is preferably registered at the client as a proxy, as discussed above, and therefore data requests generated at the client will be sent to the proxy server for further handling.

Upon receiving the request from the client 102i, the proxy server 420 forwards the request in operation 702 to the data server 440, preferably including the network address of the proxy server. As is common in network applications with packet transmission, a request may preferably include origination address and destination address. Thus, upon receiving the request transmitted in operation 702 to the data server, the data server retrieves the requested data, e.g. from its memory, and transmits the data back to the proxy server 420 in operation 703.

After receiving the requested data, the proxy server 420 determines whether the retrieved data need to be rendered, i.e. further processed or rewritten, before being transmitted to the client for further handling including visualization, as it was outlined with respect to the previous embodiments.

The operation of determining whether rendering is necessary may be executed at the proxy server 420 before or after receiving the requested data. In case it is not possible to determine from the request itself, as transmitted from the client 102i, whether the requested data need to be rendered, the requested data will preferably be retrieved first.

In case it is determined that the data need to be rendered, the requested data are transmitted in operation 704 from the proxy server 420 to the intermediate data store 430 for temporary storage.

In case it is determined that the requested data do not have to be rendered or further processed, as the client may or should itself handle the data, they may directly be transmitted from the proxy server to the client without further processing, shown in FIG. 7 at operation 704a.

After retrieving the requested data from the data server and determining that rendering is required, the proxy server 420 proceeds to generate a link message to the requested data stored in the intermediate data store 430 and transmits the link to the client 102i in operation 705.

It is noted that the operations of generating the link to the data and storing the data and determining whether rendering is necessary do not necessarily have to be performed in the order shown. For example, while examining the data request from the client a decision whether rendering is required or not may already be reached.

The link message to the data generated at the proxy server 420 and transmitted to the client in operation 705 preferably contains address information of the requested data stored in the intermediate data store 430. The link message may further contain data type information describing the requested data, as outlined with respect to the previous embodiments. This data type information may differ from the original data type information of the data retrieved from the processing server, as the retrieved data are to be rendered in order to put them into a format which may be handled, e.g. by the browser at the client. The address information may be constituted by an URL, as common in packet transmission, and the data type information may be a MIME type.

The link does not contain the requested data and the client will use the link information to proceed to retrieve data from the intermediate data store 430.

Therefore, the client 102 in operation 706 sends a request based on the link information to the processing server 410. It may be predetermined that any request upon receiving a link is transmitted from the client 102i to the processing server 410. However, is further possible that the link contains further information on a destination site for a request generated upon receiving the link message at the client.

The processing server 410, upon receiving the request in operation 706, retrieves the requested data from the intermediate data store 430 in operations 707 and 708. In the shown embodiment, the data are transmitted from the intermediate data store to the processing server upon receiving a request in operation 707. However, the intermediate data store may be directly connected to the processing server, i.e. a database which may be directly accessed by the processing server, e.g., via a system bus.

The processing server 410 upon receiving the requested data performs the required rendering operations. The rendering may be performed as outlined before with respect to previous embodiments and may for example be based on the received data format and on the availability of processing tools for data formats at the client.

Information on the particular rendering operations required may be contained in the request transmitted from the client application to the processing server in operation 706. Alternatively, the processing server may be notified by the proxy server 420, wherein the proxy server transmits the information on rendering operations required upon receiving the data request from the client 102i, and retrieving the requested data from the data server 430. After the data has been processed in accordance with the instructions provided, the rendered data are then transmitted from the processing server 410 to the client 102i in operation 709.

For further rendering of the requested data, for example in case a further page of a document is to be displayed at the client, the client and the processing server may exchange instructions and correspondingly rendered data in operation 710. Such instructions and data may include scrolling instructions and page contents for display at the client. The exchange of instructions and rendered data may be repeated.

All processing operations described with respect to FIG. 7 may be realized by a program or code sections executed on a system of data processing devices. All transmissions described with respect to FIG. 7 may be performed via networks, such as packet-switched networks, however, it is also possible that certain messages or notifications, e.g. as executed in operations 707 and 708 are executed via a system bus. Upon receiving the requested data, the client may perform further processing operations for handling the retrieved data, including visualization or similar.

It is also possible that the proxy server 120 instructs the client 102 via the link message transmitted in operation 705 to activate a data handler 511 in preparation of receiving and further processing the rendered data. The data handler may use a URL contained in the link to retrieve the requested rendered data from the processing server.

However, it is also possible that only upon receiving the rendered data the client starts the required data handler.

As an example of data transmissions executed in accordance with the embodiment described with respect to FIG. 7 it is assumed that the client requests a StarWriter document with the content type “application/starwriter” from the proxy server. The document is assumed to have an original data size of 1 MB. The proxy server will retrieve and intermediately store the requested document, and determine if rendering is necessary. In case rendering is decided to be necessary, the proxy server will generate a link message for example including a content type application/starwriter-url and a content with a link message containing for example “http://proxyxyz/temp/123456” specifying the storage location of the retrieved data. The data size of the data actually transmitted from the proxy server to the client will thus be reduced to 28 bytes, which is the size of the link message content. Thereafter the processing server will perform the rendering as required and transmit only the rendered data to the client, e.g. screen contents for local display. Thus the amount of data actually transmitted to the client, i.e. the link message from the proxy server and the rendered data from the processing server, will be substantially less than the original document.

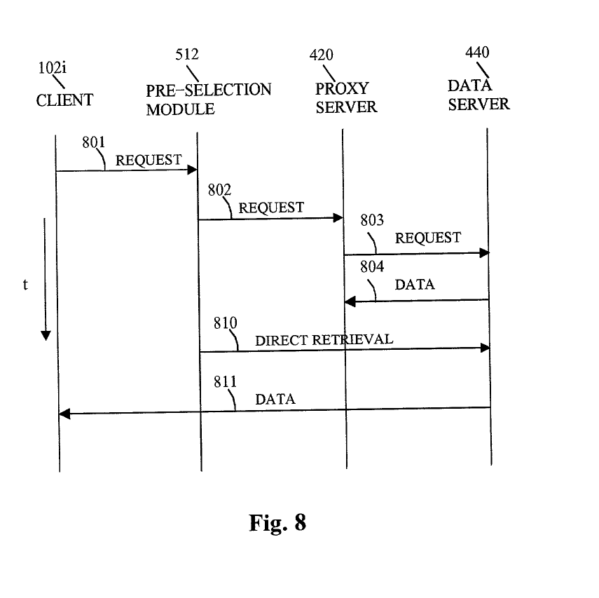

In the following a further embodiment of the invention will be described with respect to FIG. 8. FIG. 8, similar to FIG. 7, shows a time sequence of events occurring at the client 102i, the pre-selection module 512 executing on client 102i in one embodiment of the invention, the proxy server 420 and the data server 440.

In operation 801 a request for data is transmitted from the client to the pre-selection module. The request for data from the client corresponds to the request for data transmitted in operation 701 in FIG. 7, with the only difference that it is not transmitted to the proxy server, but to the pre-selection module. The pre-selection module 512 may be realized as a hardware unit or as a code section containing instructions for execution at a data processing device. The pre-selection module 512 may be located at the client or may be located remote to the client. As discussed above with respect to FIG. 5, pre-selection module 512 performs a pre-selection of requests for data into requests requiring rendering of data and requests not requiring rendering of data. The pre-selection module may thus forward requests requiring rendering directly to the proxy server, and may directly retrieve data, from e.g. data server 440 in case it is determined the requested data need not be rendered before transmission to the client.

In an embodiment of the invention, pre-selection may be based on the data type of the requested data and thus may be obtained from the request itself or may be determined based on further heuristics. It is also possible that the pre-selection depends on a domain name included into the request, as outlined before.

In case it is determined at the pre-selection module 512 that a request requiring rendering is present, this request is transmitted from the pre-selection module on the client device to the proxy server 420 in operation 802.

In this embodiment the proxy server is preferably registered at the client, i.e., at proxy registry 412 or alternatively at the pre-selection module as a proxy for all requests determined at the pre-selection module to require rendering, all other requests are directly executed.

The proxy server 420 forwards the request to the data server 440 in operation 803. Data server 440 then transmits the requested data in operation 804 to the proxy server 420. These operations correspond to operations 702 and 703 described with respect to FIG. 7.

Thereafter the proxy server 420 confirms whether rendering is indeed required, based on the retrieved data, and stores the data in the intermediate data store 430 or transmits the data back to the client, depending on the determination result, as for example described with respect to previous embodiments. The rendered data may be transmitted from the processing server 410 to the client 102i directly or may be transmitted from the processing server through the pre-selection module 512 to the client 102i.

The subsequent operations executed for rendering and transmitting the rendered data to the client correspond to the further operations previously described with respect to FIG. 7.

However, if it is determined at the pre-selection module 512 that a request for data was received from the client 102i which does not require rendering of data, a direct retrieval message is sent from the pre-selection module to the data server 420 in operation 810, e.g. via a packet-switched network. In operation 811, the data server 420 upon receiving the message from the pre-selection module transmits the data either directly to, e.g., retriever module 514 or application module 411 executing on the client 102i or through the pre-selection module.

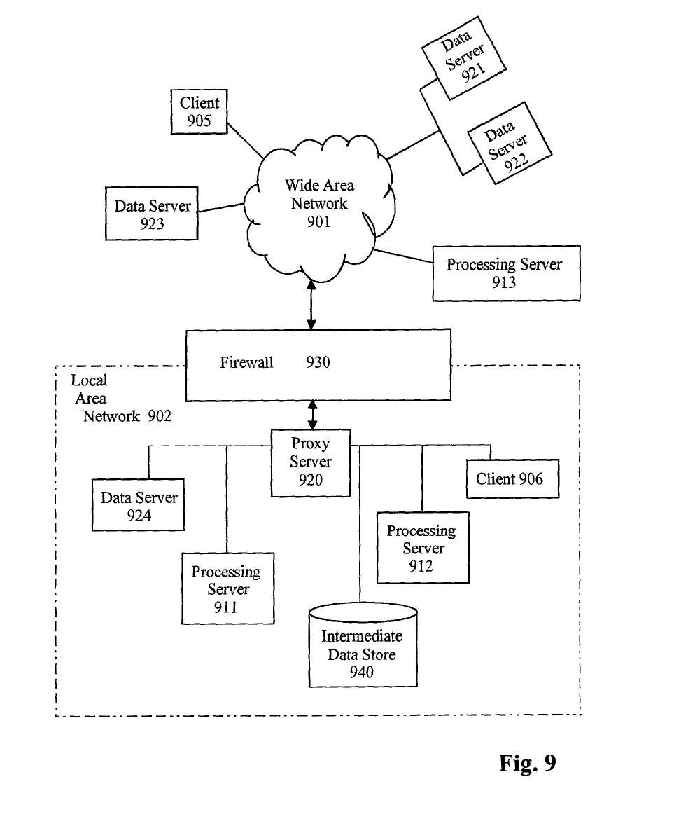

In the following a further embodiment of the invention will be described with respect to FIG. 9. FIG. 9 shows a schematic block diagram of functional entities of an access system according to an embodiment the invention.

A first client denoted with reference numeral 905 is shown to be part of public network 901. A second client denoted with reference numeral 906 is shown as part of the local area network 902. The first client 905 may be connected to the local area network via the wide area network, as shown, or directly via a dedicated communication line such as a telephone line. Data transmission may be encrypted.

Further, FIG. 9 shows three processing servers 911, 912 and 913, wherein processing servers 911 and 912 are part of the local area network 902 and wherein the third processing server 913 is part of the public network.

Still further, FIG. 9 shows four data servers 921, 922, 923 and 924, wherein the data servers 921, 922 and 923 are part of the wide area network 901 and the fourth data server 924 is part of the local area network 902. However, the configuration depicted in FIG. 9 is an exemplary system, and as known in the art, an arbitrary number of clients, proxy servers, processing servers and data servers may be provided inside the local area network and/or in the wide area network.

In case a data request is generated by the first client 905, it may be transmitted either via a dedicated line or the wide area network 901, e.g., including wireless transmission, to the local area network and to the proxy server 920.

In case a data request is generated at the second client 906, which is part of the local area network 902, it may be transmitted through the local area network to the proxy server 920.

Upon receiving the request from any of the shown clients, the proxy server 920 will retrieve the requested data from an appropriate one of the data servers 921, 922, 923 and 924. In case the corresponding data server is part of the local area network, the retrieval of the data by the proxy server may be executed through the local area network, in case the data server is part of the wide area network 901, the requested data will be transmitted from the wide area network to the local area network. This transmission may cross a firewall 930, protecting the local area network from unauthorized access from the outside.

As is known in the art, a firewall generally is a method for keeping a network secure. It can for example be implemented in a router that filters out unwanted packets, or it may use a combination of technologies in routers and hosts. Firewalls may be used to give users access to public networks in a secure fashion as well as to separate a company's public Web server from its internal network. They may also be used to keep internal network segments secure.

The proxy server, as described above, may store the retrieved data in the intermediate data store 940. The proxy server may generate a link message containing address information of the stored data and transmit this message to the requesting client. Preferably, the link may contain address information on an appropriate processing server determined by the proxy server for further handling of the data request.

Upon receiving the link message, the client will then connect to the processing server determined by the link and transmit a data request using the further information contained in the link.

However, it is also possible that the request from the client upon receiving the link from the proxy server is distributed among the available processing servers, according to availability by a different entity. In this case a determined processing server need not be specified in the link from the proxy server.

Thereafter, as already outlined with respect to previous embodiments, the processing server receiving the request from the client will precede to retrieve the requested data from the intermediate data store 940 and will render the retrieved data as outlined before. The rendered data will then be transmitted to the requesting client for further processing or visualization.

It is noted that is also possible that a plurality of proxy servers and intermediate memory stores is provided in order to provide scalability of the system. In this case requests from the clients may be transmitted to a proxy server depending on availability, communication load or physical location of the client and respective proxy server.

It is noted that the different entities of the system are not necessarily distributed over a public network and a local area network, it is possible that communications are executed via a single network.

Although particular embodiments of the invention have been described, it will be appreciated that many modifications/additions and/or substitutions may be made within the scope of the invention.

What is claimed is:

1. A system for accessing data stored at a remote host in a computer network, comprising:
a proxy server having a code section including instructions for receiving a request for data from a client, and making a determination whether the requested data should be rendered before transmission to the client; and
a processing server coupled to the proxy server and having a code section including instructions for receiving the rendering determination from the proxy server, rendering the requested data, and transmitting the rendered data to the client.

2. The system of claim 1, wherein
the proxy server further comprises a code section including instructions for storing the requested data in an intermediate data store if it is determined that the requested data should be rendered before transmission to the client; and
the processing server further comprises a code section including instructions for retrieving data stored in the intermediate data store.

3. The system of claim 1, wherein
the proxy server includes a code section including instructions for transmitting address information to the processing server, wherein the address information corresponds to the storage location of the requested data at a data server; and
the processing server includes a code section containing instructions for retrieving the requested data from the data server.

4. The system of claim 3, wherein the proxy server further comprises
a code section containing instructions for generating a link message containing address information corresponding to the requested data; and
a code section containing instructions for transmitting the link message to the client.

5. The system of claim 4, wherein the link message further includes data type information describing the requested data.

6. The system of claim 4, wherein the link message further includes a client identifier and a session identifier.

7. The system of claim 3, wherein the address information of the requested data comprises a URL and the data type information comprises a MIME type.

8. The system of claim 3, wherein the client further comprises a data handler including a code section containing instructions for establishing a communication link between the client and the processing server and for receiving the rendered data from the processing server.

9. The system of claim 1, wherein the proxy server includes a code section containing instructions for directly transmitting the requested data to the client upon the proxy server determining that the requested data do not have to be rendered before transmission to the client.

10. A computer-based method comprising:
receiving a data request from a client at a proxy server;
evaluating the data request at the proxy server to determine whether data specified in the data request should be rendered;
generating a rendering request for transmission to a processing server upon the proxy server determining that data specified in the data request should be rendered before transmission to the client;
generating rendered data by rendering data at the processing server upon receiving said rendering request from the proxy server; and
transmitting the rendered data to the client.

11. The method of claim 10, comprising
retrieving the requested data from a data server;
storing the requested data in an intermediate data store upon the proxy server determining that the requested data should be rendered before transmission to the client; and
transmitting the requested data from the intermediate data store to the processing server.

12. The method according to claim 10, wherein
transmitting from the proxy server to the processing server address information corresponding to the location of the requested data on a data server; and
retrieving the requested data from the data server to the processing server using the address information.

13. The method of claim 10, comprising
generating a link message containing address information of the requested data; and transmitting the link message to the client.

14. The method of claim 13, wherein the link message further includes address information of the processing server.

15. The method of claim 14, wherein the address information of the requested data comprises a URL.

16. The method of claim 13, wherein the link message further includes data type information describing the requested data.

17. The method of claim 16, wherein the data type information comprises a MIME type.

18. The method of claim 13, wherein the link message further includes a client identifier and a session identifier.

19. The method of claim 10, further comprising:
establishing a communication link between the client and the processing server; and
receiving the rendered data from the processing server.

20. The method of claim 10, further comprising transmitting the requested data directly to the client upon the proxy server determining that the requested data should not be rendered before transmission to the client.

21. The method of claim 10, comprising pre-selecting requests for data into a first category comprising requests wherein the requested data should be rendered, and a second category wherein the requested data should not be rendered;
transmitting requests in the first category to the proxy server; and
transmitting the requested data corresponding to requests in the second category directly to the client.

22. The method according to claim 10, wherein at least the proxy server, the processing server, and the intermediate data storage are connected on a local area network.

23. A computer-based method for accessing data in a computer network, comprising:
receiving a request for data from a client at a proxy server;
determining whether the requested data have to be rendered before transmission to the client; and
authorizing a processing server to render the data at and to transmit the rendered data to the client.

24. The method of claim 23, further comprising
retrieving the requested data from a data server;
storing the requested data in an intermediate data store upon the proxy server determining that the requested data have to be rendered before transmission to the client; and
authorizing the processing server to retrieve the data stored in the intermediate data store.

25. The method of claim 23, wherein
the proxy server transmits address information of the requested data to the processing server, and
the processing server retrieves the requested data from a data server using the address information.

26. The method of claim 23, comprising
generating a link message containing address information of the requested data; and
transmitting the link message to the client.

27. The method of claim 26, wherein the link message further includes address information of the processing server.

28. The method of claim 27, wherein the address information of the requested data comprises a URL.

29. The method of claim 26, wherein the link message further includes data type information describing the requested data.

30. The method of claim 29, wherein the data type information is expressed using MIME data representations.

31. The method of claim 26, wherein the link message further includes a client identifier and a session identifier.

32. The method of claim 23, further comprising activating a data handler for establishing a communication link between the client and the processing server and for receiving the rendered data from the processing server.

33. The method of claim 23, further comprising directly transmitting the requested data to the client if the proxy server determines that the requested data do not have to be rendered before transmission to the client.

34. The method of claim 23, wherein the processing server may comprise any of a plurality of processing servers configured to render and transmit data, and the proxy server may receive data from a plurality of clients and may retrieve data from a plurality of data servers.

35. A method for accessing data in a network, comprising:
receiving a message at a processing server to render data requested by a client;
retrieving the requested data from an intermediate data store;
transmitting the requested data to the processing server;
rendering the requested data at the processing server; and
transmitting the rendered data to the client.

36. The method of claim 35, wherein the processing server is instructed by a data handler running at the client to retrieve the requested data from the intermediate data store.

37. The method of claim 35, wherein the processing server
receives address information corresponding to the requested data, and
retrieves the requested data from a data server using the address information.

38. The method of claim 35, wherein the message to render data requested by the client is pre-selected.

39. A computer program product comprising a medium configured to store or transport computer readable code for a method comprising:
receiving a request for data from a client at a proxy server;
determining whether the requested data have to be rendered before transmission to the client;
rendering the data at a processing server; and
transmitting the rendered data to the client.

40. A proxy server comprising:
a processor;
a memory connected to said processor, and containing
code containing instructions configured, upon execution of said instructions by the processor, to cause the proxy server
to receive a data request from a client;
to determine whether the data requested by the client should be rendered, and
to retrieve the requested data from a data server; and
to authorize a processing server to retrieve and render the requested data in accordance with the determination of the proxy server, and to transmit the rendered data to the client.

41. The proxy server of claim 39, wherein the memory further includes a code section containing instructions configured upon execution of said instructions by the processor to cause the proxy server
to store the requested data in an intermediate data store upon the proxy server determining that the requested data should be rendered before transmission to the client, and
to authorize the processing server to retrieve the data stored in the intermediate data store.

42. The proxy server of claim 39, wherein the memory further includes a code section containing instructions configured upon execution of said instructions by the processor to cause the proxy server
to transmit address information of the requested data to the processing server, and
to instruct the processing server to retrieve the requested data from a data server using the address information.

43. The proxy server of claim 39, wherein the memory further includes a code section containing instructions configured upon execution of said instructions by the processor to cause the proxy server
to generate a link message containing the address information of the requested data, and to transmit the link message to the client.

44. The proxy server of claim 39, wherein the link message comprises
address information of the processing server, and
data type information describing the requested data.

45. The proxy server of claim 43, wherein the link message further comprises a client identifier and a session identifier.

46. The proxy server of claim 39, wherein the memory further includes a code section containing instructions configured upon execution of said instructions by the processor to cause the proxy server
to activate a data handler to establish a communication link between the client and the processing server, and
to receive the rendered data from the processing server.

47. The proxy server of claim 39, wherein the memory further includes a code section containing instructions configured, upon execution of said instructions by the processor, to cause the proxy server
to directly transmit the requested data to the client if the proxy server determines that the requested data do not have to be rendered before transmission to the client.

48. The proxy server of claim 39, wherein the processing server authorized by the proxy server comprises
a processor;
a memory operatively connected to said processor, and storing code containing instructions configured, upon execution of said instructions by the processor, to cause the processing server
to receive an instruction message to render data requested by a client;
to retrieve the requested data from an intermediate data store; and
to contain instructions for transmitting the rendered data to the client.

49. The proxy server of claim 47, wherein the memory of the processing server further includes code containing instructions configured, upon execution of said instructions by the processor, to cause the processing server
to receive an instruction message from a data handler at the client to establish a communication link between the client and the processing server.

50. The proxy server of claim 47, wherein the memory of the processing server further includes code containing instructions configured, upon execution of said instructions by the processor, to cause the processing server
to retrieve the requested data based on address information corresponding to an intermediate data store.

51. The proxy server of claim 47, wherein the memory of the processing server further includes code containing instructions configured, upon execution of said instructions by the processor, to cause the processing server
to retrieve the requested data based on address information from a data server.

52. The proxy server of claim 47, wherein the proxy server, the processing server, and the intermediate data store are connected by a local area network.
